(19) United States
(12) Patent Application Publication
(10) Pub. No.: US 2008/0037133 A1
(43) Pub. Date: Feb. 14, 2008

(54) APPARATUS AND METHOD FOR DETERMINING PRESENCE OF CURVATURE IN PERSONAL VANITY MIRRORS

(76) Inventor: Douglas Grady Preston, Beaumont, TX (US)

Correspondence Address: Mr. Doug Preston, 4608 Ford St, Beaumont, TX, 77706, US

(21) Appl. No.: 11/836,691

(22) Filed: Aug. 9, 2007

Related U.S. Application Data
(60) Provisional application No. 60/821,824, filed on Aug. 9, 2006.

(51) Int. Cl. G02B 27/14

(52) U.S. Cl. 359/631

(57) ABSTRACT

An apparatus and its method of use by an observer to visually determine what, if any, distortions are introduced by unexpected curvature in a personal vanity mirror. The apparatus remains simple to operate and is convenient for casual use. By providing a familiar reference pattern against which to compare the image reflected by a mirror, the observer can make more well-informed decisions.

### RELATED U.S. APPLICATION DATA

Provisional application No. 60/821,824 filed Aug. 09, 2006

### RELATED U.S. CLASSIFICATIONS

382/309.311, 382/312.313, 382/312.321.324

### FIELD OF THE INVENTION

The present invention relates in general to an apparatus and its method of use by an observer to visually compare images reflected from a personal vanity mirror with an unchanging reference pattern to determine what, if any, distortions are introduced by unexpected curvature present in the mirror.

### BACKGROUND OF THE INVENTION

1. Introduction

Mirrors are perhaps one of the most studied and ubiquitous technologies known from antiquity. Advancements in fabrication and applications throughout the centuries have taken a simple concept (now largely taken for granted) from mysterious curiosity, to eclectic fad, to advanced research and industrial tool, to ubiquitous social necessity.

People can readily appreciate the social benefits of self-observation in mirrors. Mirrors aid millions of daily personal decisions regarding all manner of hygiene, hairstyle, fashion, and appearance.

The unconscious assumption made by a typical observer looking into a personal vanity mirror is that the surface of the mirror is not only planar but also oriented such that the normal of the plane of the mirror is reasonably horizontal.

Whether through neglect or devious intent, the owner of a mirror may introduce slight physical alterations to a mirror that create cylindrical curvature in the reflecting surface and distort the image seen by an observer. The personal benefits identified above are placed at jeopardy when the assumption of planarity does not hold.

A small amount of cylindrical curvature can be introduced in a full-length mirror by placing a strip of moderately thick material between the back of the mirror and the wall or fixture behind it, along the mirror's horizontal or vertical meridian. By introducing a small amount of convex cylindrical curvature, an observer's apparent image can either be enlarged or reduced, in width or height, as determined by the amount and orientation of introduced curvature. Even a small amount of curvature can cause a large difference in the apparent image, and yet go unrecognized by the observer because the assumption of planarity is rarely called into question.

Many routine personal judgments are predicated on such unchallenged assumptions that can influence purchase decisions and have non-trivial economic consequences.

Prior art provides no means to detect the presence of such curvature in personal vanity mirrors that is both convenient and simple enough to become as ubiquitous and accessible as mirrors themselves have become.

To address the problem, the present invention must provide the observer an opportunity to juxtapose a stable, familiar reference pattern along with a (possibly distorted) reflection pattern as presented by the mirror under test. By comparing the two, the observer can develop a judgment regarding the fidelity of the mirror's reflection, and possibly modify their confidence in subsequent decisions.

2. Description of the Related Art

From prior art, it is known that the magnification equation of a cylindrically curved mirror can be given as:

$$MagnificationFactor = \frac{{w}_{i}}{{w}_{o}} = - \frac{{d}_{i}}{{d}_{o}}$$

Where: wₒ represents the width of the object being observed, dₒ represents the distance from the mirror surface to the object being observed, wᵢ represents the apparent width of the image formed in the mirror, dᵢ represents the apparent distance from the mirror surface to the image formed in the mirror.

In the case of a planar mirror, the distance to the image is opposite in sign, and equal in magnitude to the distance to the object. No magnification occurs, and the reflected image appears correctly to the observer.

Normal human visual acuity is generally accepted to permit resolution of a spatial pattern separated by a visual angle of one minute of arc ( 1/60th of one degree). Numerically, that is about 0.016667 degrees.

For a visual angle this small, we can use the following relationship to approximate feature size S at a given distance D.

$$VisualAngle = ( \frac{S}{D} ) radians$$

If an observer were located 600 mm (about arm's length) from the nearest point of a planar mirror, and the apparatus of the present invention were held two thirds of that distance toward the mirror, then the apparent distance from the observer to the reflected image of the apparatus would be four thirds of the observer's distance to the mirror, or 800 mm. (which we will use as the value of D)

After converting the acuity angle from degrees to radians and rearranging, we calculate a value of S=0.2327 mm

$${S}_{mm} = ( \frac{VisualAngle}{57.2958} ) * {D}_{mm}$$

$${S}_{mm} = ( \frac{0.016667}{57.2958} ) * {800}_{mm}$$

$${S}_{mm} = {0.2327}_{mm}$$

To remain discernable by an observer under normal operating conditions, the reflected images of any small visual features, such as the plurality of alternating sectors 240 and 250 should appear well larger than this minimum feature size in any embodiment of the present invention.

### SUMMARY OF THE INVENTION

The invention disclosed herein includes an apparatus and method for its use to determine if a personal vanity mirror is subject to curvature that significantly distorts the observer's image by making the observer's reflection appear either thinner or wider than it would normally appear if the mirror were planar and undistorted.

Personal vanity mirrors are normally mounted in a vertical orientation; either affixed to a wall or set into a floor-standing frame. They are generally used for the purpose of observing one's own reflection while dressing, etc.

In almost all cases, they are assumed to be planar, introducing no optical distortions that would misrepresent the observer's appearance. By a variety of circumstances, a mirror's mounting may fail to keep it planar, allowing a horizontal or vertical curvature to be introduced into the mirror. Such curvature, if undetected, could tend to distort one's image and adversely impact one's judgment regarding clothing selection, self-image, etc.

For example, to an observer standing one meter from a mirror with a vertical curvature of as little as 0.06 Diopters, a measurement of hip width of 33.5 inches (nominally, fashion size 8) would appear to be only 32.5 inches (nominally, fashion size 6). The observer's image would therefore appear about 3% smaller than usual; in this case, not quite one full dress size smaller than usual. Such an misrepresentation may well be flattering, but is false nonetheless and significantly misleading.

A curvature this small is barely noticeable if it is unexpected. For a one meter wide mirror, the rearward deflection (e.g. t_{w} of FIG. 4) of the sides of a mirror having this curvature would be less than 4 millimeters. At a nominal observing distance of one meter, such a small deflection (and the image distortion) would be difficult to detect without aid.

### BRIEF DESCRIPTION OF THE DRAWINGS

The present invention can be further understood by reference to the following description and attached drawings that illustrate aspects of the invention. Other features and advantages will be apparent from the subsequent detailed description of the invention, taken in conjunction with the accompanying drawings, which illustrate, by way of example, the principles of the present invention.

Referring now to the drawings in which like reference numbers represent corresponding parts throughout:

FIG. 1. Illustrates an example of the obverse face of the hand-portable card with aperture, along with the reference pattern, instructions, and assessment patterns.

FIG. 2. Illustrates an example of the reverse face of the hand-portable card with aperture, along with the reflective pattern.

FIG. 3. Illustrates an Observer using the apparatus while standing in front of a mirror.

FIG. 4. Illustrates various geometric relationships between the size of an object and the size of its image when reflected by a curved mirror.

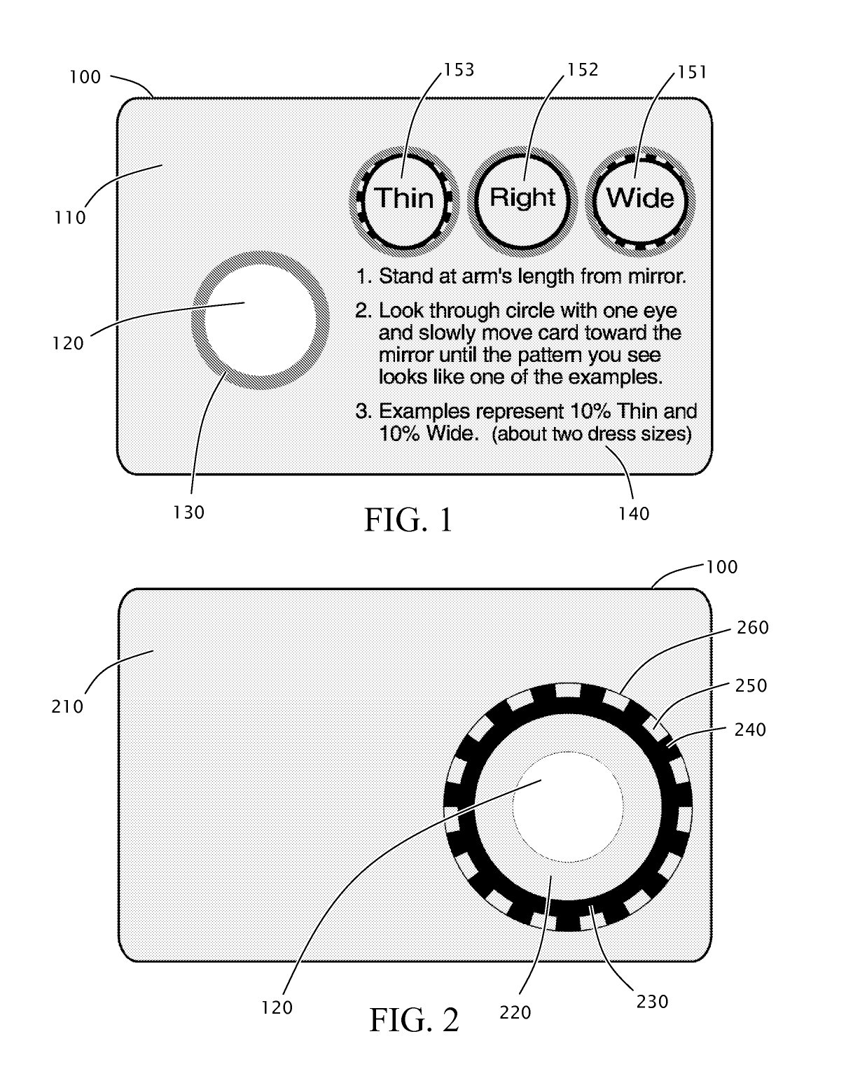

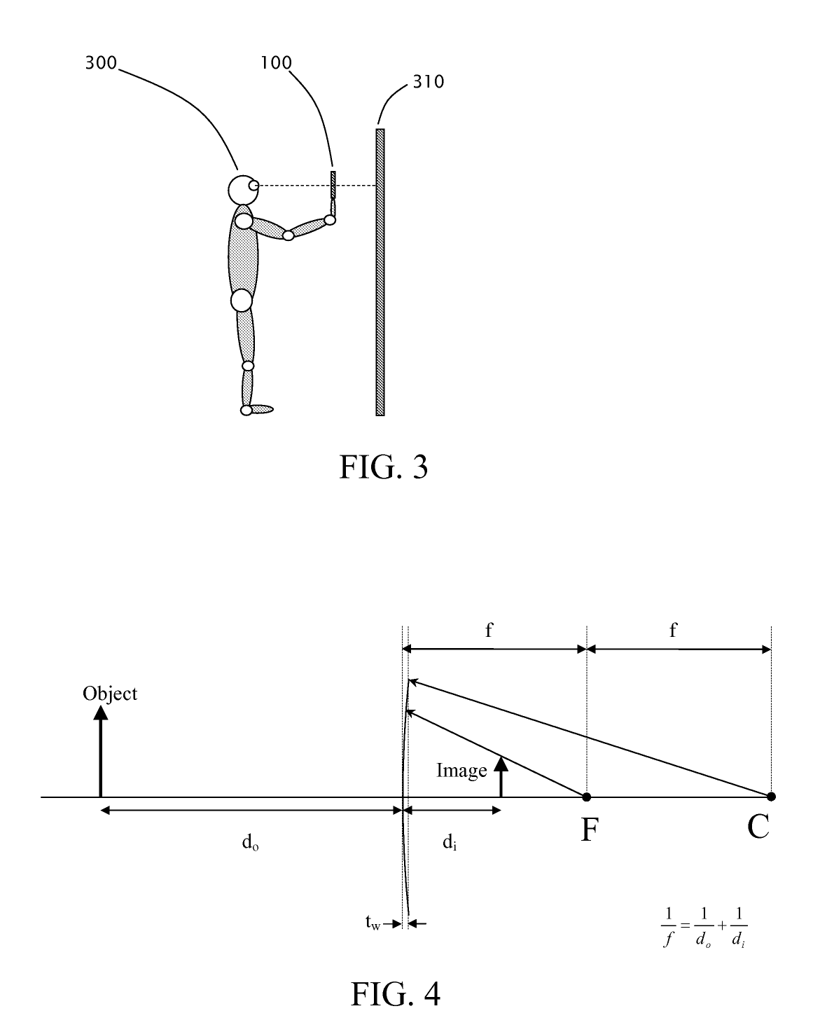

### DETAILED DESCRIPTION OF THE PREFERRED EXEMPLARY EMBODIMENT

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

There are many alternative ways that the apparatus can be implemented:

The hand-portable card 100 may be round, rectangular, or some other polygonal shape.

Said card may be any size and thickness convenient for hand-held operation and discreet storage. In the preferred embodiment, the card takes on the size and shape of a standard wallet card, about 86 mm wide by 54 mm high by 1 mm thick.

Said card may be of any opaque, rigid, durable material such as plastic, metal, glass, or paper.

The size of aperture 120 may vary, but the preferred embodiment scales the aperture diameter as 16 mm (half of the maximum diameter of the region 230, which is therefore 32 mm). This permits the nominal operating distance from observer to card to be two thirds the distance from observer to mirror; a convenient ratio when the observer is standing within arm's length of the mirror. At this distance ratio, a planar mirror would reflect an image of region 230 of the reflective pattern 260 which would naturally appear fully inscribed within the aperture 120.

The instructions and captions may be rendered in any language familiar to the intended user, and may be placed on either face of the card. The preferred embodiment locates the instructions 140 and assessment patterns 151, 152 and 153 on the obverse face 110, leaving the reverse face 210 available for the reflective pattern 260.

Alternate assessment patterns may illustrate varying amounts of curvature. The preferred exemplary embodiment renders the assessment pattern 151 to illustrate what the composite image of 130 and the reflection of 260 would look like if the mirror under test were subject to a “widening” magnification of about 10% (110% of horizontal or 90% of vertical). The preferred exemplary embodiment renders the assessment pattern 152 to illustrate what the composite image of 130 and the reflection of 260 would look like if the mirror under test were not subject to any horizontal or vertical curvature. The preferred exemplary embodiment renders the assessment pattern 153 to illustrate what the composite image of 130 and the reflection of 260 would look like if the mirror under test were subject to a “slimming” magnification of about 10% (90% of horizontal or 110% of vertical). The preferred illustration of 10% magnification factors is chosen to roughly correspond to an apparent difference of two fashion dress sizes, which in prior art are defined effectively at hip-measurement increments of about five percent.

Selecting a multiple of dress sizes is consistent with the intent of the preferred embodiment which is to aid the observer in the context of garment shopping.

The preferred exemplary embodiment scales the outermost diameter of the reference pattern 130 to be 20 mm.

The preferred exemplary embodiment scales the outermost diameter of the reflective pattern 260 to be 36 mm.

The aperture 120, reference pattern 130, and reflective pattern 260 are concentric in all embodiments of the present invention. That center is displaced with respect to the card in the preferred exemplary embodiment, but can be placed anywhere within the extent of the shape of the card as long as 120, 130, and 260 remain concentric and all are contained within the extent of the shape of the card.

The preferred exemplary embodiment includes fifteen pairs of alternating sectors 240 and 250 each of which subtends twelve degrees of angle measured from the center of the aperture 120. They are each arranged to be adjacent only to sectors of the shade opposite their own.

The embodiments of the invention in which an exclusive property or privilege is claimed are defined as follows:

1. An apparatus for determining presence of cylindrical curvature in personal vanity mirrors comprising:
a hand-portable card 100 having a circular aperture 120;
and a reference pattern 130 appearing on obverse face 110, encircling said aperture of said card;
and a set of usage instructions 140 printed on said obverse face of said card;
and a plurality of assessment patterns as exemplified by 151, 152 and 153 appearing on said obverse face of said card;
and a reflective pattern 260 appearing on reverse face 210, encircling said aperture of said card.

2. The apparatus according to claim 1, wherein the said reflective pattern is comprised of:
an innermost circularly bounded region 220 devoid of markings, encircling and concentric to said aperture 120;
and a next innermost circularly bounded region 230 completely marked, encircling and concentric to said region 220;
and a next innermost circularly bounded region encircling and concentric to said region 230, comprised of a plurality of sectors, said sectors alternately completely marked as illustrated at 240 and completely unmarked as illustrated at 250;
and an outermost circularly bounded region 260 completely marked, encircling and concentric to said plurality of sectors as exemplified by 240 and 250.

3. The apparatus according to claim 1, wherein the reference pattern is comprised of:
a circularly bounded region 130 completely marked, encircling and concentric to said aperture 120.

4. A method of determining presence of curvature in personal vanity mirrors, including the steps of:
(a) instructing the observer 300 by the set of usage instructions 140 according to claim 1, to stand nearby and face the mirror under test 310 at approximately arm's length;
(b) further, holding the apparatus of claim 1 between said observer and said mirror, and parallel to said mirror, such that said observer can look with one eye through the aperture 120 and see the region 230 of reflective pattern 260 reflected in said mirror;
(c) further, positioning the aperture of the apparatus of claim 1 along the line of sight normal to the presumed plane of the mirror and approximately two thirds the distance from the observer to the mirror and such that if the region 230 appears elliptical, its major axis is fully and optimally visible within aperture 120;
(d) further, observing the composite appearance of the reflected image of the reflective pattern 260 through the aperture 120, as it appears inscribed within the reference pattern 130;
(e) further, compare the composite image observed in step (d) to the assessment patterns 151, 152, and 153 to determine the greatest similarity and thereby determine the associated indication of the presence and nature of curvature.
